(19) United States
(12) Patent Application Publication
(10) Pub. No.: US 2025/0008967 A1
(43) Pub. Date: Jan. 9, 2025

(54) AUGMENTED REALITY SPACE DEFINED BY SMART-DECO DEVICES

(71) Applicants: GREGORY A. PICCIONELLI, WESTLAKE VILLAGE, CA (US); Gregory B Gulliver, GRAYSLAKE, IL (US)

(72) Inventors: GREGORY A. PICCIONELLI, WESTLAKE VILLAGE, CA (US); Gregory B Gulliver, GRAYSLAKE, IL (US)

(21) Appl. No.: 18/772,246

(22) Filed: Jul. 14, 2024

Related U.S. Application Data
(63) Continuation-in-part of application No. 17/892,077, filed on Aug. 20, 2022.
Application No. 17/892,077 is a continuation of application No. 16/690,087, filed on Nov. 20, 2019, now Pat. No. 11,641,860.
(60) Provisional application No. 62/769,962, filed on Nov. 20, 2018.
(60) Provisional application No. 63/235,607, filed on Aug. 20, 2021.
(60) Provisional application No. 63/513,571, filed on Jul. 14, 2023.

(51) Int. Cl. A21D 13/47; A23G 3/34; A47G 33/08; F21V 35/00; H04L 67/125; H04W 4/80; H05B 47/155; H05B 47/165; H05B 47/19

(52) U.S. Cl. CPC A21D 13/47; A23G 3/0097; A47G 33/0818; F21V 35/003; H05B 47/155; H05B 47/165; H05B 47/19; A47G 2033/0827; H04L 67/125; H04W 4/80

(57) ABSTRACT

Identification of a physical area for display of virtual content in an augmented reality device using smartdeco devices.

### RELATED PATENTS

This application is a continuation-in-part of U.S. patent application Ser. No. 17/892,077, titled “Conductor and Member Interactive Decoration,” filed on Aug. 20, 2022, that is a continuation of and claims priority to U.S. patent application Ser. No. 16/690,087, titled “Cake Decoration System,” that issued on May 9, 2023, as U.S. Pat. No. 11,641,860, that claimed priority to U.S. Provisional Patent Application No. 62/769,962, titled “Cake Decoration System,” filed on Nov. 20, 2018, U.S. patent application Ser. No. 17/892,077 also claims priority to U.S. Provisional Patent Application No. 63/235,607, titled “Conductor and Member Interactive Decoration,” filed on Aug. 20, 2021; This application also claims priority to U.S. Provisional Patent Application No. 63/513,571, titled Augmented Reality Space Defined by Smartdeco Devices,” file on Jul. 14, 2023. In addition to the claim of priority, all the above applications and patents are incorporated in their entirety herein.

### TECHNICAL FIELD

The present invention relates generally to augmented reality and more particularly to defining a physical area in an augmented reality space.

### BACKGROUND

Smartdeco is a term that is used to define a collection of devices that are able to be coordinated in such a way to provide a show using lights, audio, and processor control. An example of smartdeco would be a plurality of ornaments on a Christmas tree that are able to perform a mixed media reconfigurable show or coordinated show (e.g. show with sounds, lights, and/or media). As these shows appear in the physical world, and all people present at a celebration (e.g. wedding, birthday, Christmas, or Holi, to name but a few) may view it without special glasses or headsets.

But, if a person has an augmented reality headset additional content could be provided, but the room or environment needs to be mapped or previous mapping accessed for virtual reality content to be shown in a proper location in the room. Therefore, there is a need to quickly identify a virtual reality content area for displaying virtual content in a room that is quick and requires limited processing power.

### SUMMARY

Smartdeco devices typically will have lights and or displays that are mapped in a room. That mapping may be accessed to enable augmented reality displays to quickly identify and supply content to predetermined areas of a room or venue. In other implementations, the smartdeco devices may provide a signal that an augmented reality device can identify and quickly map an area for virtual content. For example, at Christmas, a Christmas tree with a plurality of smartdeco ornaments periodically or in response to detection or notification of an augmented reality device being present flash or provide other signals that enable the augmented reality device to map an area around the Christmas tree for displaying a virtual Santa's sleigh flying around the Christmas tree.

Other devices, apparatus, systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, reference numerals designate corresponding parts throughout the different views.

FIGS. 1A-1E, are art deco devices on a Christmas Tree in accordance with an example implementation.

FIG. 2, an area defined around the Christmas Tree of FIG. 1 in an augmented reality system.

FIG. 3, a block diagram of an augmented reality device accessing a smartdeco room mapping.

FIG. 4, a flow diagram of an augmented reality device accessing virtual content of a smartdeco system.

### DETAILED DESCRIPTION

Smartdeco devices (for example, ornaments, cake decorations, electric candle, balloons, holiday decorations) typically will have lights and or displays controlled by a processor that are mapped in a room and communicate with a controller that has its own processor. That mapping may be accessed to enable augmented reality displays to quickly identify and supply content to predetermined areas of a room or venue. In other implementations, the smartdeco devices may signal that an augmented reality device can identify and quickly map an area for virtual content. For example, at Christmas, a Christmas tree with a plurality of smartdeco ornaments periodically or in response to detection or notification of an augmented reality device being present flash or provide other signals that enable the augmented reality device to map an area around the Christmas tree for displaying a virtual Santa's sleigh flying around the Christmas tree. Furthermore, geometric formulas and typical ceiling heights, tree heights, tree shape, room shape, furniture size, and furniture shape may be used to further refine or define the location of smartdeco devices and distances between smartdeco devices for display of augmented reality images in addition to open space for augmented reality images to be displayed. In other implementations, a geometric shape definition may be used to define the area (i.e. circle, rectangle, square, pentagon).

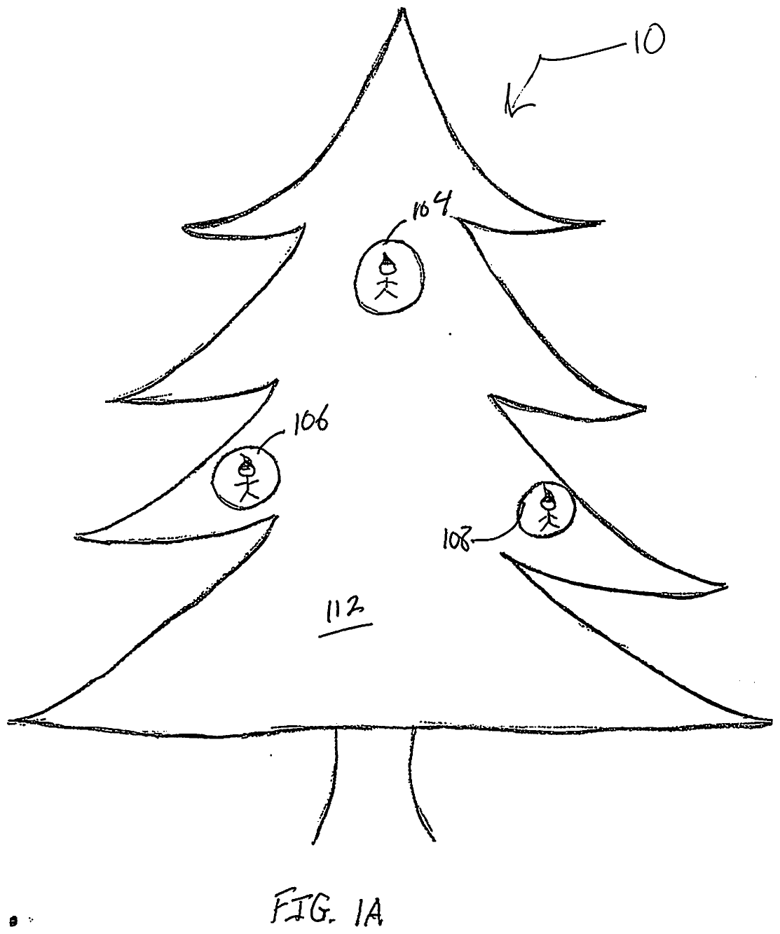

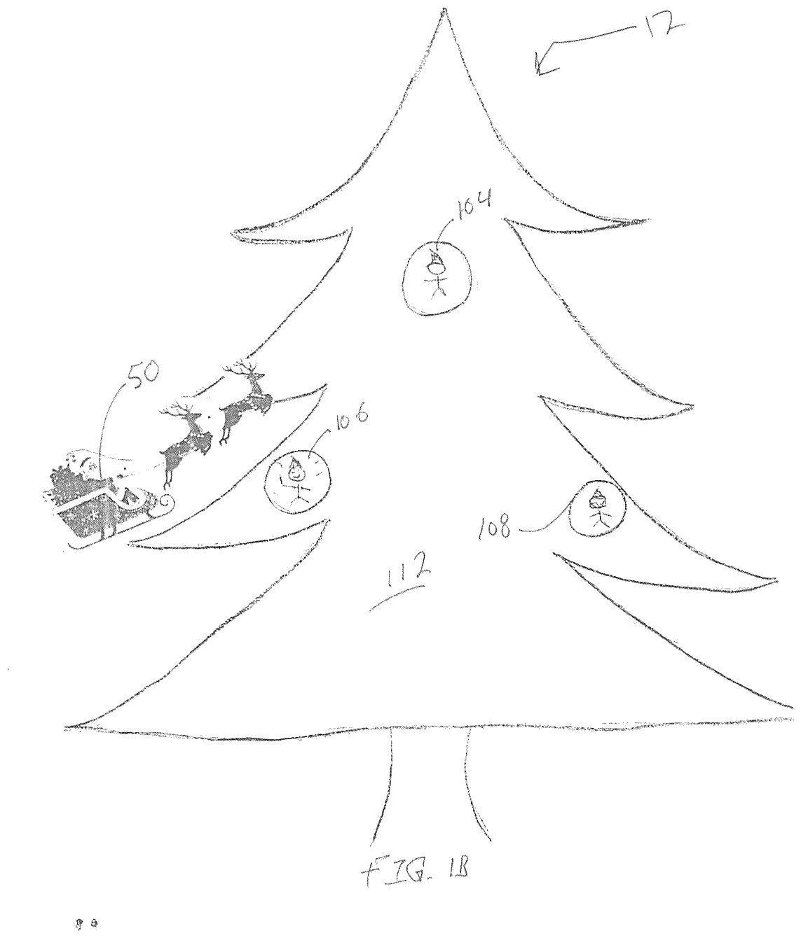

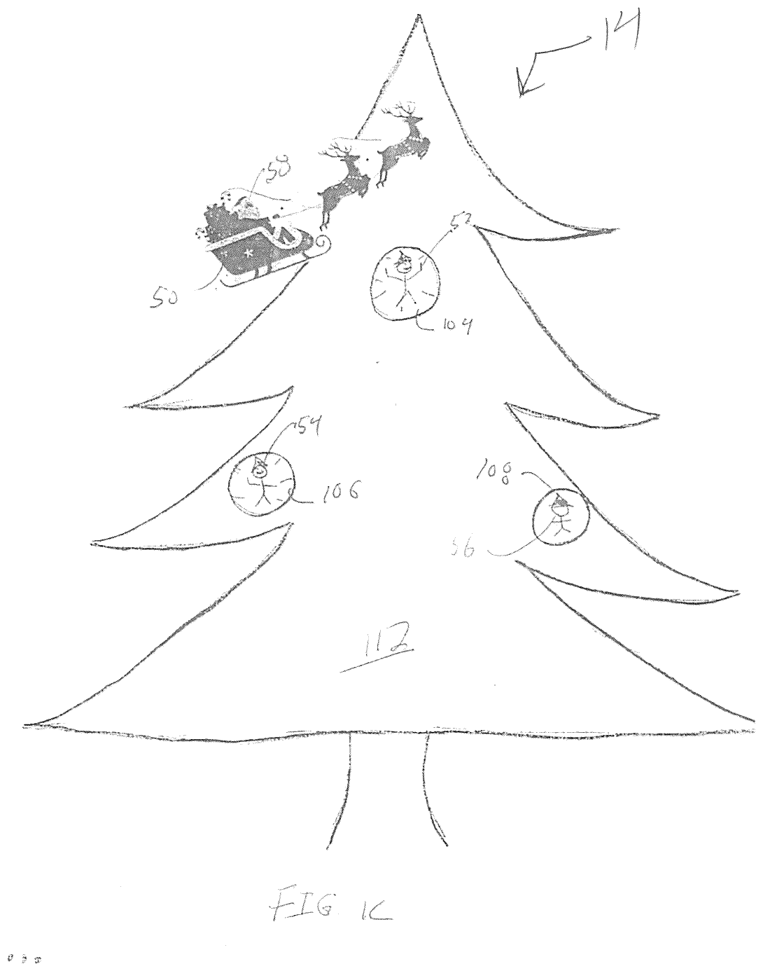

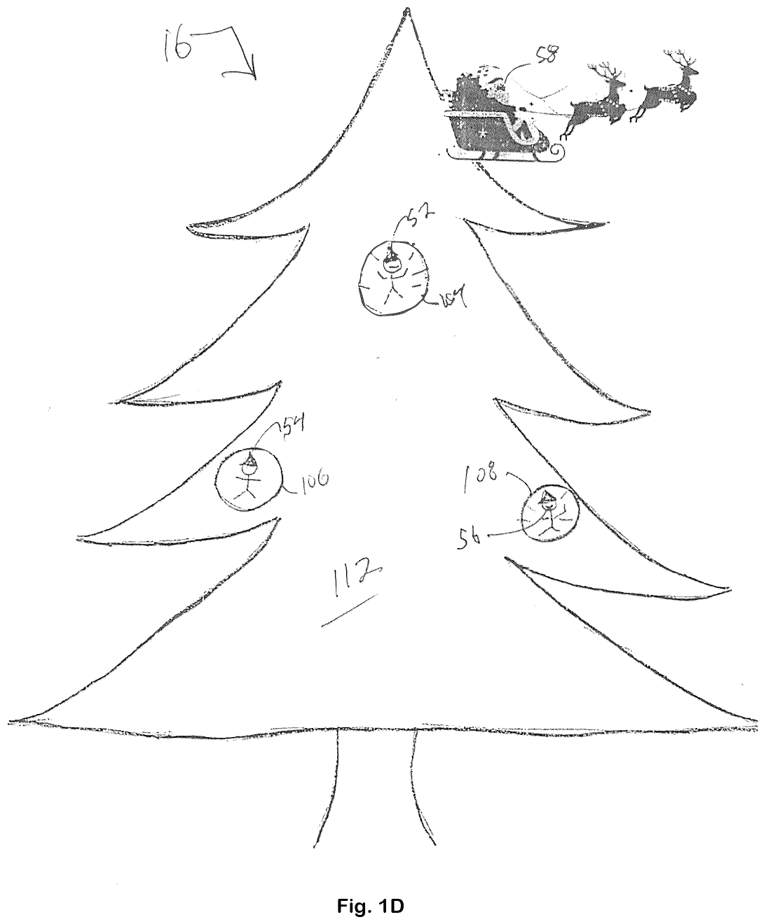

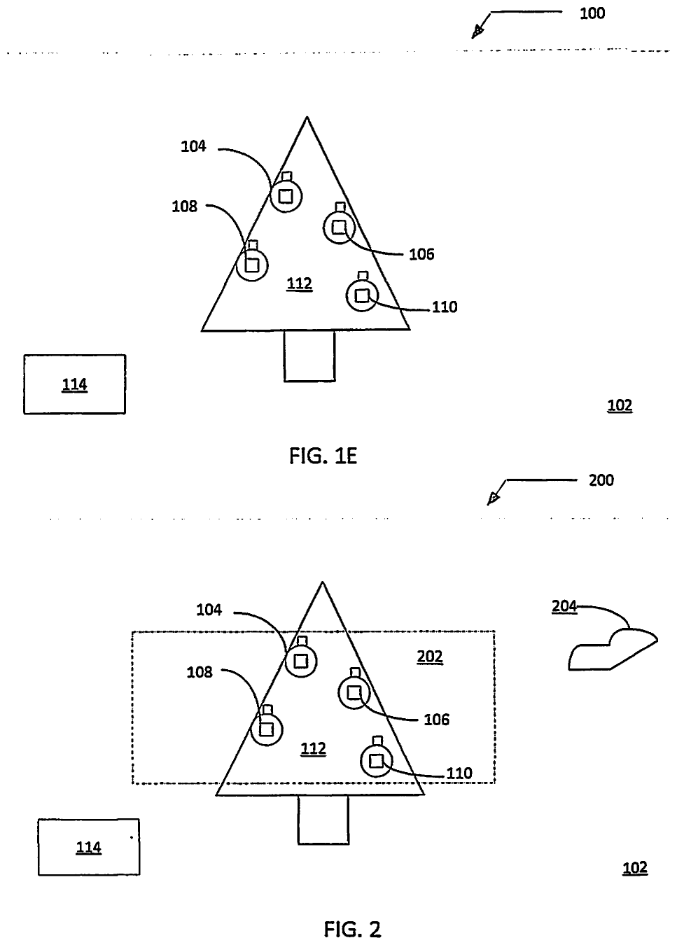

In FIG. 1A, a drawing 10 of a Christmas tree 112 having smartdeco devise 104-108 is depicted. The smartdeco devices depicted each have their own processor, display, and speaker. The smartdeco devices are able to communicate with a controller via a network interface. Depending upon the implementation, the network interface may be wireless, such as Bluetooth, WiFi, RF, or wired, such as i2c, 3 wire bus, network over the power cable, or wired ethernet. The control is then able to communicate content to the smartdeco devices and provide conductor control to media shows.

Turning to FIG. 1B, a view from an augmented reality display 12 is depicted in accordance with an example implementation. The Christmas tree 112 has smartdeco devices 104-108 whose location is known to the augmented reality system. With the shape of the Christmas tree known, and the location of the smartdeco devices 104-108 known, the augmented reality system defines the area around the Christmas tree for displaying an augmented reality image, Santa Claus flying his sleigh (augmented reality content) 50.

In FIG. 1C, another view from the augmented reality display 14 of the Christmas tree 112 is depicted in accordance with an example implementation. The smartdeco devices 104-108, each displays a media image of an elf 52-56. The augmented reality system displaying the image of Santa Claus flying his sleigh 50, communicates the proximity (either by location of Santa's sleigh, distance to each smartdeco device 104-108 depending upon implementation) to a smartdeco device. When in proximity to a smartdeco device, such as smartdeco device 104, the image of the elf 52 may respond by appearing to wave (media content is activated, may be visual media content/audio media content/multimedia visual content) via receiving a signal directly from the augmented reality system or via the augmented reality system communicating with the controller, depending upon the implementation. The augmented reality system may also react to the proximity by having the image of Santa 58 in Santa's sleigh also wave to the elf. It is also noted, that more than one smartdeco device may react to the augmented reality image's proximity, such as smartdeco device 106 image of the elf 54 also waving to Santa as smartdeco device 104 image waves.

Turning to FIG. 1D, another view from the augmented reality display 16 of the Christmas tree 112 is depicted. In this view, Santa's sleigh with Santa Claus 58 has progressed to the other side of the tree and elf media images 52 and 56 respond to the proximity by waving to Santa Claus 58. In other implementations, augmented reality images may be statically placed in relation to the known locations of smartdeco devices in a room.

In FIG. 1E is a drawing 100 of a smartdeco system 102 with smartdeco devices 104-110 on a Christmas Tree 112. The smartdeco system 100 is able to play coordinated media shows using the smartdeco devices 104-110. The placement of the smartdeco devices 104-110 has been mapped in the smartdeco system 100 in order to coordinate the show. For example, a Christmas carol is played across all ornaments with coordination (including starting and stopping). A Controller 114 is configured, loaded, or otherwise notified of the ornament placement on the Christmas tree in a room and/or tree mapping. The mapping is stored and otherwise accessible to the controller 114. In the current example, the controller 114 communicates with the smartdeco devices 104-110 via a network, a wireless network 116 in this example. The controller 114 may act as a conductor to calculate timing for sounds and images used by the smartdeco devices. In some implementations, the controller 114 may generate media shows (sound, graphics, timing) that are then downloaded to the different smart devices via their network connections. The smartdeco devices may be synchronized with a common clock or heartbeat signal. In other implementations, an audio or light signal may be used (provided the smartdeco devices have microphones and/or cameras).

The controller 114 is a processor-controlled network device that is able to process media files into a media shows and communicate the media show parts to the different smartdeco devices. Some examples of such devices are smartphones, tablets, laptop computers, desktop computers, single-board computers, and dedicated processing controller devices. Typically, the controller has a network interface for transmitting and receiving data, memory for storing applications and operating system, input/output devices, and a display. A program or application may be downloaded into a general computing device and executed, or in a dedicated controller, the programming may be stored and executed upon booting. In yet other implementations, an application may generate a media show that is then transferred to the controller 114, which distributes the show to the smartdeco devices.

Turning to FIG. 2, a diagram 200 of area 202 defined around the Christmas tree 112 by smartdeco devices 104-110 of FIG. 1 in an augmented reality system 204. The smartdeco devices 104-110 act as fiducials for the augmented reality system 204 to define the area 202. The defining the area marked by the smartdeco devices 104-110 are on a tree in the current example, but in other examples, they may be placed around a room and define an area in the room. In yet other implementations, the augmented reality system 204 may have sensors that assist in determining the space or area it is operating in addition to using the smartdeco devices 104-110.

In one implementation, the augmented reality system 204 signals to the smartdeco controller 114 to activate the smartdeco devices 104-110. A predetermined pattern or other identifier is activated in the smartdeco devices 104-110 by the smartdecor controller 114 via the network. In other implementations, the augmented reality system 204 may directly communicate with the smartdeco devices 104-110 to activate them. An example of this would be a broadcast message on the network that is automatically received by all smartdeco devices 104-110 and/or controller 114. In yet other implementations, the augmented reality device, when detected by the controller 110 as being on the same activates or otherwise triggers a process to define the area, instructing the augmented reality device user to view the smartdeco devices 104-108 in the room.

The augmented reality system 204 then processes the received visual data (along with sensor data in some implementations) with a processor to map an area for virtual images to be displayed in the room. The processing may occur on an augmented reality device or in a cloud environment accessed by the augmented reality device.

A visual processing algorithm that uses at least one smartdeco device seen by the augmented reality system 204 defines an area 202 beyond the physical object of a tree 112 that encompasses the smartdeco devices 104-110.

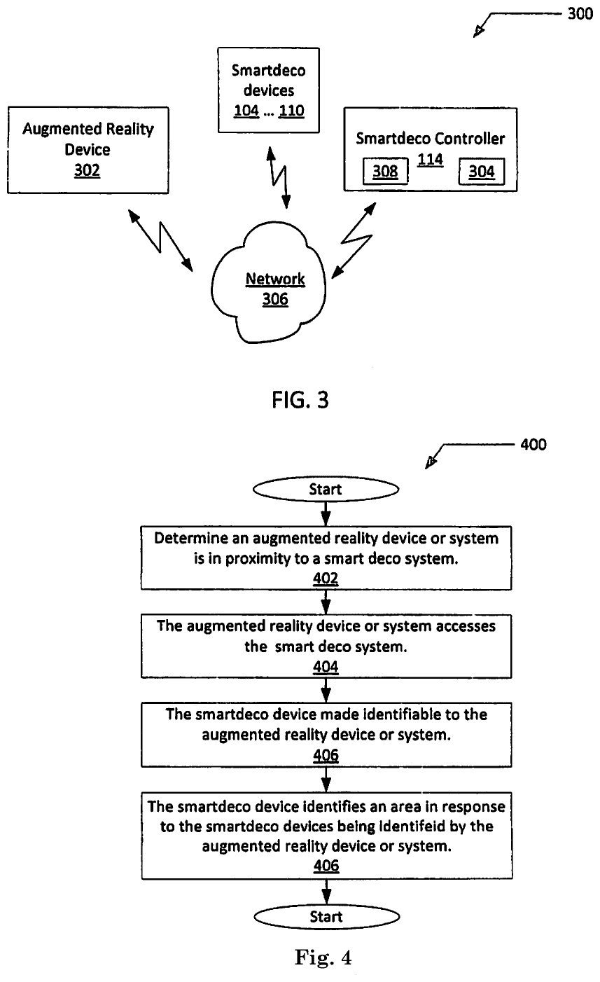

In FIG. 3, a block diagram 302 of an augmented reality device 302 accessing a smartdeco room mapping 304 via network 306. By accessing the smartdeco Controller 114, the augmented reality device 302 may download the mapping of the room along with any virtual content stored or identified by the smartdeco controller 114.

Virtual content may be bought, traded, or exchanged in the smartdeco system via the smartdeco controller 114. A marketplace for virtual content may be accessed via the network by the smartdeco controller, either directly or indirectly. The virtual content bought, sold, and traded may be stored in a datastore, such as a blockchain, database, or insertable media that is inserted into the virtual controller.

In other implementations, the area 202 defined around the smartdeco devices 104-110 may be determined by the augmented reality device 302 and virtual content 308 accessed from the smartdeco controller 114. In other implementations, the virtual content may be contained in the cloud, and the augmented reality device may be directed to access it via the smartdeco controller 114 or smartdeco devices 103-110. In yet other implementations, devices may signal to the augmented reality device 302 by signaling with an auditory signal or visual signal (flashing light or light pattern).

Turning to FIG. 4, a flow diagram 400 of an augmented reality device 302 accessing virtual content 308 of a smartdeco system 102. The first step, 402, is to determine whether an augmented reality device 302 or system is in proximity to a smartdeco system 102. In step 404, the augmented reality device or system accesses the smart deco system. Step 406 has the smartdeco devices 104-110 made identifiable to the augmented reality device 302 or system. The smartdeco devices 104-110 are used by the augmented reality device 302 to identify an area 202 in response to the smartdeco devices 104-110 being identified by the augmented reality device 302 or system.

It will be understood and is appreciated by persons skilled in the art, that one or more processes, sub-processes, or process steps described in connection with FIG. 4 may be performed by hardware and/or software (machine-readable instructions). If the approach is performed by software, the software may reside in software memory in a suitable electronic processing component or system, such as one or more of the functional components or modules schematically depicted in the figures.

The software in software memory may include an ordered listing of executable instructions for implementing logical functions (that is, “logic” that may be implemented either in digital forms such as digital circuitry or source code or in an analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or another system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer readable medium may selectively be, for example, but is not limited to, an electronic, magnetic, optical, electromagnetic, or semiconductor system, apparatus or device. More specific examples, but nonetheless a non-exhaustive list, of tangible computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, and then compiled, interpreted, or otherwise processed in a suitable manner if necessary, and stored in computer memory.

The foregoing detailed description of one or more embodiments of the approach for augmented reality space defined by smartdeco devices has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems, or applications. Presently unforeseen or unanticipated alternatives, modifications, variations, or improvements may be subsequently made by those skilled in the art which are also intended to be encompassed by the appended claims. Therefore, the spirit and scope of any appended claims should not be limited to the description of the embodiments contained herein.

What is claimed is:

1. A method for defining a physical area for an augmented reality device comprising:
activating an at least one device;
identifying the at least one device by the augmented reality device; and
determining an area associated with the device by the augmented reality device, wherein the augmented reality device displays an augmented reality content in the area.

2. The method for defining the physical area for the augmented reality device of claim 1, wherein the at least one device is an at least one smartdeco device.

3. The method for defining the physical area for the augmented reality device of claim 2, where identifying includes communicating between a smartdeco controller that is associated with the at least one smartdeco device and the augmented reality device.

4. The method for defining the physical area for the augmented reality device of claim 3, wherein the communicating includes transmitting from the smartdeco controller to the augmented reality device a location of the at least one smartdeco device.

5. The method for defining the physical area for the augmented reality device of claim 3, wherein the communicating is via Bluetooth.

6. The method for defining the physical area for the augmented reality device of claim 3, wherein the communicating is via WiFi.

7. The method for defining the physical area for the augmented reality device of claim 1, where determining the area associated with the at least one device includes defining the area by a distance from the at least one device.

8. The method for defining the physical area for the augmented reality device of claim 1, where determining the area associated with the at least one device includes defining the area by application of a geometric shape to define the area.

9. The method for defining the physical area for the augmented reality device of claim 1, wherein the device is an ornament.

10. The method for defining the physical area for the augmented reality device of claim 1, wherein the device is an electric candle.

11. The method for defining the physical area for the augmented reality device of claim 1, where identifying the at least one device includes identifying a signal from the at least one device.

12. The method for defining the physical area for the augmented reality device of claim 11, wherein the signal is an auditory signal.

13. The method for defining the physical area for the augmented reality device of claim 11, wherein the signal is a visual signal.

14. The method for defining the physical area for the augmented reality device of claim 1, further includes activating media on the at least one device in response to a proximity of the augmented reality content to the at least one device.

15. The method for defining the physical area for the augmented reality device of claim 14, wherein activating content includes activating visual media content.

16. The method for defining the physical area for the augmented reality device of claim 14, wherein activating content includes activating audio media content.
